(19) United States
(12) Patent Application Publication
(10) Pub. No.: US 2016/0303914 A1
(43) Pub. Date: Oct. 20, 2016

(54) Tire Having A Reduced Nominal Pressure And An Increased Relative Deflection Under Nominal Load

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Benoît FOUCHER, Clermont-Ferrand Cedex 9 (FR)

(21) Appl. No.: 15/103,236

(22) PCT Filed: Nov. 25, 2014
(86) PCT No.: PCT/EP2014/075547

§ 371 Date: Jun. 9, 2016

(30) Foreign Application Priority Data
Dec. 9, 2013 (FR) 1362287

(51) Int. Cl. B60C 9/08; B60C 15/00; B60C 9/20; B60C 1/00; B60C 3/04; B60C 9/00; B60C 11/00; B60C 13/00; B60C 9/22

(52) U.S. Cl. CPC B60C 9/08; B60C 13/00; B60C 15/00; B60C 9/20; B60C 9/22; B60C 3/04; B60C 9/0007; B60C 9/2006; B60C 11/0008; B60C 1/00; B60C 9/005; B60C 2009/2016; B60C 2009/2019; B60C 2009/0425

(57) ABSTRACT

Tire comprising a crown reinforcement formed of at least two working crown layers of reinforcing elements. The tire has a nominal pressure (Pn) of between 4 and 8 bar and a relative deflection (Fr) under nominal load that satisfies the relationship Fr≧0.14+(Pn−5)×0.013. The crown reinforcement ly comprises a layer of reinforcing elements parallel to one another within the layer and oriented circumferentially, the reinforcing elements of the carcass reinforcement having a diameter less than 1 mm and comprising threads of a diameter greater than 0.16 mm, the reinforcing elements of the carcass reinforcement being metal cords, advantageously non-wrapped cords, exhibiting in a permeability test a flow rate of less than 20 cm³/min, and the radial distance, measured in the equatorial plane, between the exterior surface of the tread and the interior surface of the tire being less than 32 mm.

The present invention relates to a tire with a radial carcass reinforcement and more particularly to a tire intended to be fitted to vehicles carrying heavy loads, such as, for example, lorries, tractors, trailers or buses, fitted with wheels the rims of which have a nominal diameter greater than or equal to 22.5 inches.

In general, in tires of the heavy goods type, the carcass reinforcement is anchored on each side in the region of the bead and is surmounted radially by a crown reinforcement made up of at least two layers which are superposed and formed of threads or cords that are parallel within each layer and crossed from one layer to the next, making with the circumferential direction angles of between 10° and 45°. The said working layers, that form the working reinforcement, may even be covered with at least one layer referred to as a protective layer and formed of reinforcing elements advantageously made of metal and extensible, referred to as elastic elements. It may also comprise a layer of low extensibility metal threads or cords making with the circumferential direction an angle of between 45° and 90°, this layer, referred to as a triangulation layer, being situated radially between the carcass reinforcement and the first crown layer referred to as a working layer, formed of parallel threads or cords at angles at most equal to 45° in terms of absolute value. The triangulation layer forms with at least the said working layer a triangulated reinforcement which, under the various stresses that it is subjected to, exhibits very little by way of deformation, the triangulation layer having the essential role of reacting to the transverse compression loadings to which all of the reinforcing elements in the crown region of the tire are subjected.

Cords are said to be inextensible when the said cords under a tensile force equal to 10% of the rupture force, exhibit a strain of at most 0.2%.

Cords are said to be elastic when the said cords under a tensile force equal to the rupture load exhibit a strain of at least 3% with a maximum tangent modulus of less than 150 GPa.

Circumferential reinforcing elements are reinforcing elements which make, with the circumferential direction, angles contained in the range +2.5°, −2.5° about 0°.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction that intersects the axis of rotation of the tire and is perpendicular thereto.

The axis of rotation of the tire is the axis about which it turns during normal use.

A radial or meridian plane is a plane containing the axis of rotation of the tire.

The circumferential median plane or equatorial plane is a plane perpendicular to the axis of rotation of the tire and which divides the tire into two halves.

As far as the metal threads or cords are concerned, the rupture force (maximum load in N), rupture strength (in MPa) and elongation at break (total elongation in %) measurements are taken under tensile load in accordance with standard ISO 6892, 1984.

Certain present-day tires known as “road” tires are intended to run at a high average speed over increasingly long journeys, because of the improvements to the road network and the growth of the motorway network throughout the world. All of these conditions in which such a tire has to run undoubtedly allows an increase in the distance that the tire can cover, since tire wear is lower. This increase in life measured in distance, combined with the fact that such conditions of use are likely, under heavy load, to result in relatively high crown temperatures, entails an at least proportional increase in the endurance potential of the crown reinforcement of the tires.

Indeed there are stresses applied to the crown reinforcement, more particularly shear stresses between the crown layers, and this, in the event of too great an increase in the operating temperature at the ends of the axially shortest crown layer, cause cracks to appear and spread through the rubber at the said ends. The same problem is encountered at the edges of two layers of reinforcing elements, the said other layer not necessarily having to be radially adjacent to the first.

In order to improve the endurance of the crown reinforcement of tires, French application FR 2 728 510 proposes positioning, on the one hand between the carcass reinforcement and the crown reinforcement working ply radially closest to the axis of rotation, an axially continuous ply formed of inextensible metal cords that make an angle at least equal to 60° with the circumferential direction and the axial width of which is at least equal to the axial width of the shortest working crown ply and, on the other hand, between the two working crown plies, an additional ply formed of metal elements oriented substantially parallel to the circumferential direction.

In addition, French application WO 99/24269 notably proposes, on each side of the equatorial plane and in the immediate axial continuation of the additional ply of reinforcing elements substantially parallel to the circumferential direction, that the two working crown plies formed of reinforcing elements that are crossed from one ply to the next be coupled over a certain axial distance and later uncoupled using profiled elements of rubber compound over at least the remainder of the width common to the said two working plies.

The layer of circumferential reinforcing elements usually consists of at least one metal cord wound to form a turn of which the angle of laying with respect to the circumferential direction is less than 8°. The cords initially manufactured are coated with a rubber compound before being set in place. This rubber compound then penetrates the cord under the effect of pressure and temperature when the tire is being cured.

The results thus obtained in terms of endurance and wear during prolonged road running at high speed are usually satisfactory. However, it would seem that under certain running conditions, notably when overloaded, certain tires sometimes exhibit more pronounced wear across part of their tread.

Furthermore, whatever the solutions envisaged as set out hereinabove, the presence of an additional layer of reinforcing elements leads to a greater mass of tire and to higher tire manufacturing costs.

Document WO 10/069676 proposes a layer of circumferential reinforcing elements distributed at a variable spacing. Depending on the chosen spacings, more widely spaced in the central and intermediate parts of the layer of circumferential reinforcing elements, it is possible to create tires of which the performance in terms of endurance is satisfactory with performance in terms of wear that is improved. Furthermore, by comparison with a tire comprising a layer of circumferential reinforcing elements distributed at a constant spacing, it is possible to reduce the mass and cost of such tires even though it is necessary to make up for the absence of reinforcing elements by filling with masses of polymer.

It is an object of the invention to provide tires for heavy vehicles the endurance and wear performance of which is maintained or even improved, for road use whatever the conditions of use and the mass of which is further reduced by comparison with that of the tires as described previously.

This objective is achieved according to the invention by a tire for a vehicle of the heavy vehicle type equipped with wheels the rims of which have a nominal diameter greater than or equal to 22.5 inches, with a radial carcass reinforcement of which the nominal pressure (Pn) is between 4 and 8 bar and the relative deflection (Fr) under nominal load satisfies the relationship Fr≧0.14+(Pn−5)×0.013, comprising a crown reinforcement formed of at least two working crown layers of reinforcing elements, crossed from one layer to the other and making with the circumferential direction angles of between 10° and 45°, itself capped radially by a tread, the said tread being connected to two beads by two sidewalls, the crown reinforcement additionally comprising at least one layer of reinforcing elements that are parallel to one another within the layer and oriented circumferentially, the reinforcing elements of the carcass reinforcement having a diameter less than 1 mm, and being made up of threads of diameters strictly greater than 0.16 mm, the said reinforcing elements of the carcass reinforcement being metal cords, advantageously non-wrapped cords, exhibiting, in what is known as the permeability test, a flow rate less than 20 cm³/min and the radial distance measured in the equatorial plane between the exterior surface of the tread and the interior surface of the tire being less than 32 mm.

The nominal load is that defined by the ETRTO (European Tire and Rim Technical Organization) standards for a given size of tire.

The nominal diameter of a rim is also that defined by the ETRTO standards.

By definition, the deflection under nominal load of a tire is its radial deformation, or relative variation in radial height, as this tire passes from an unladen inflated state to a laden inflated state statically, under nominal load conditions and at 80% of the nominal pressure, the nominal pressure and nominal load being those defined by the 2013 ETRTO standards, for a given size of tire. The relative deflection is defined by the ratio of the variation in radial height of the tire to half the distance between the outside diameter of the tire and the measured nominal diameter (diameter of the seat) of the rim. The outside diameter of the tire is measured statically unladen but inflated to the nominal pressure.

Measurements of the thickness of rubber compound are taken on a cross section of a tire, the tire therefore being in an uninflated state.

Within the meaning of the invention, elements that are parallel to one another within the layer and oriented circumferentially may be rectilinear reinforcing elements or reinforcing elements directed chiefly in a circumferential direction and undulating about this main direction.

Again within the meaning of the invention, the said at least one additional layer of circumferential reinforcing elements may also within the meaning of the invention be positioned radially on the inside of the said at least two working crown layers, radially on the outside of the said at least two working crown layers, or even between the said at least two working crown layers.

Advantageously according to the invention, the reinforcing elements of the said at least one additional layer of reinforcing elements that are parallel to one another within the layer and oriented circumferentially are metal cords.

The test referred to as the permeability test makes it possible to determine the longitudinal permeability of the tested cords to air by measuring the volume of air passing through a test specimen under constant pressure over a given length of time. The principle behind such a test, which is well known to those skilled in the art, is to demonstrate the effectiveness of the treatment applied to a cord in making it impermeable to air; it has been described, for example, in standard ASTM D2692-98.

The test is carried out on cords extracted directly, by stripping, from the vulcanized rubber plies that they reinforce, and which have therefore been penetrated with cured rubber.

The test is carried out on a 2 cm length of cord, which is therefore coated with its surrounding rubber composition (or coating rubber) in the cured state, as follows: air is injected into the inlet end of the cord at a pressure of 1 bar, and the volume of air at the outlet end is measured using a flow meter (calibrated for example from 0 to 500 cm³/min) During measurement, the test specimen of cord is immobilized in a compressed seal (for example a seal made of dense foam or of rubber) so that only the amount of air passing through the cord from one end to the other along the longitudinal axis thereof is taken into consideration by the measurement; the airtightness of the seal itself is tested beforehand using a test specimen made of solid rubber, i.e. one with no cord.

The higher the longitudinal impermeability of the cord, the lower the mean air flow rate measured (averaged over 10 test specimens). Because the measurement is performed with a precision of ±0.2 cm³/min, measured values of 0.2 cm³/min or lower are considered to be zero; these correspond to a cord that can be qualified as airtight (completely airtight) along its axis (i.e. in its longitudinal direction).

This permeability test is also a simple way of indirectly measuring the extent to which a rubber composition has penetrated the cord. The higher the degree of penetration of the cord with the rubber, the lower the measured flow rate.

The degree of penetration of a cord can also be estimated using the method described hereinafter. In the case of a layered cord, the method involves first of all eliminating the outer layer on a test specimen of a length of between 2 and 4 cm so that the sum of the lengths of rubber compound with respect to the length of the test specimen can then be measured in a longitudinal direction and along a given axis. These measurements of lengths of rubber compound exclude the spaces along this longitudinal axis that have not been penetrated. These measurements are repeated along three longitudinal axes distributed about the periphery of the test specimen and repeated for five test specimens of cord.

When the cord comprises several layers, the first, elimination, step is repeated on the layer which has newly become the outer layer and the lengths of rubber compound are measured again along the longitudinal axes.

A mean of all the ratios of lengths of rubber compound to lengths of test specimen thus determined is then calculated in order to define the degree of penetration of the cord.

Advantageously, according to the invention, the said reinforcing elements of the carcass reinforcement are made up of threads of diameter less than or equal to 0.20 mm.

For preference, according to the invention, the nominal pressure of the tire is less than 7.5 bar and more preferably greater than 5 bar.

For preference also according to the invention, the relative deflection under nominal load is greater than 18%.

Tires according to the invention effectively have a lower mass by comparison with tires of the same size produced in the more usual way, with notably a reduced thickness of the crown and notably a reduced thickness of the tread. The usual crown thickness for such a tire, which corresponds to the radial distance measured in the equatorial plane between the exterior surface of the tread and the interior surface of the tire, is usually greater than 35 mm, the thickness of the tread being greater than 22 mm.

According to the invention, the thickness of the tread is advantageously less than 20 mm.

In order to allow a reduction in thickness at the crown, the inventors have decided to lean towards use of tires with a nominal pressure that is reduced and preferably less than 7.5 bar combined with a relative deflection under nominal load that is increased and preferably greater than 18%. This is because tire conditions of use with an inflation pressure of the order of 20% less than in the usual conditions of use actually allow less demand to be placed on the crown of the tire, notably in terms of wear. The inventors have also been able to demonstrate that the increase in circumferential rigidity caused by the presence of at least one layer of reinforcing elements that are parallel to one another within the layer and oriented circumferentially, allows even wear to be maintained.

The inventors have also been able to demonstrate that carcass-reinforcement reinforcing elements with a diameter of less than 1 mm and made up of threads of diameters strictly greater than 0.16 mm, combined with degrees of penetration that are higher than usual, according to the invention, appear to allow the tire to withstand the stresses generated during running and notably in the contact patch with a nominal pressure preferably less than 7.5 bar associated with a relative deflection under nominal load that is preferably greater than 18%. The reinforcing elements of the carcass reinforcement are then effectively subjected to fatigue phenomena.

The results obtained with the tires according to the invention have thus demonstrated that they allow satisfactory endurance and wearing properties to be maintained when running under conditions of inflation pressure of the order of 20% lower than the usual inflation pressures, the said tires having a relative deflection under nominal load that is preferably greater than 18%.

The inventors have also been able to demonstrate that the combination of conditions in which the inflation pressure is of the order of 20% less than the usual inflation pressures with degrees of penetration of the reinforcing elements of the carcass reinforcement that are higher than usual leads to less of an adverse effect on the reinforcing elements, notably the carcass reinforcement, as a result of “thermooxidation” phenomena. The inventors thus also propose reducing the thicknesses of the radially innermost polymer compounds forming the cavity of the tire in order further to decrease the mass of the tire.

The invention relates more particularly to tires of the “heavy goods” type, in which the ratio of the height on rim H to its maximum axial width S, or shape ratio, is strictly greater than 0.64.

The aspect ratio H/S is the ratio of the height H of the tire on the rim to the maximum axial width S of the tire, when the latter is mounted on its service rim and inflated to its nominal pressure. The height H is defined as the difference between the maximum radius of the tread and the minimum radius of the bead.

Advantageously according to the invention, the radial distance, measured in the equatorial plane, between the exterior surface of the tread and the interior surface of the tire is greater than 15 mm.

According to a preferred embodiment of the invention, the ratio between the width of the tread and the maximum width of the tire is less than or equal to 0.80. The ratio between the width of the tread and the maximum width of usual tires is generally at least 3.5% greater compared with the ratio according to our invention which is less than or equal to 0.80. The inventors have been able to demonstrate that use at a pressure of the order of 20% less than the usual pressures makes it possible to reduce the width of the tread while at the same time maintaining the wearing properties, notably because an area of contact of the tread with the ground is maintained. The tire according to the invention can thus be further lightened, the width of the layers that make up the crown reinforcement being furthermore decreased in relation with the reduction in width of the tread.

The widths are measured on a tire mounted on its rim, inflated to the nominal conditions (those of the tire according to the invention being 80% of those of the usual tire) unladen.

According to one preferred embodiment of the invention, the cords of the carcass reinforcement exhibit, in what is referred to as the permeability test, a flow rate of less than 10 cm³/min and preferably still of less than 2 cm³/min.

According to an advantageous alternative form of the invention, the metal reinforcing elements of at least one layer of the carcass reinforcement are cords having at least two layers, at least an internal layer being sheathed by a layer made of a polymer composition such as a composition of a rubber that is non-crosslinkable, crosslinkable or crosslinked, preferably based on at least one diene elastomer.

Cords referred to as “layered cords” or “multilayered” are cords made up of a central core and of one or more practically concentric layers of strands or threads arranged around this central core.

The invention further proposes a tire radial carcass reinforcement for a vehicle of the heavy vehicle type equipped with wheels the rims of which have a nominal diameter greater than or equal to 22.5 inches, of which the nominal pressure (Pn) is between 4 and 8 bar and the relative deflection (Fr) under nominal load satisfies the relationship Fr≧0.14+(Pn−5)×0.013, comprising a crown reinforcement formed of at least two working crown layers of reinforcing elements, crossed from one layer to the other and making with the circumferential direction angles of between 10° and 45°, itself capped radially by a tread, the said tread being connected to two beads by two sidewalls, the said crown reinforcement additionally comprising at least one layer of reinforcing elements that are parallel to one another within the layer and oriented circumferentially, the reinforcing elements of the carcass reinforcement having a diameter less than 1 mm, and being made up of threads of diameters strictly greater than 0.16 mm, the said metal reinforcing elements of at least one layer of the carcass reinforcement being cords having at least two layers, at least an internal layer being sheathed by a layer made of a polymer composition such as a composition of a rubber that is non-crosslinkable, crosslinkable or crosslinked, preferably based on at least one diene elastomer and the radial distance measured in the equatorial plane between the exterior surface of the tread and the interior surface of the tire being less than 32 mm.

Within the meaning of the invention, cords, having at least two layers, at least one internal layer being sheathed by a layer made of a polymer composition exhibit, in the test referred to as the permeability test, a flow rate less than 20 cm³/min and advantageously less than 2 cm³/min.

The expression “composition based on at least one diene elastomer” means, in the known way, that the composition contains this or these diene elastomers as a predominant fraction (i.e. in a mass fraction greater than 50%).

It will be noted that the sheath according to the invention extends continuously around the layer it covers (i.e. that this sheath is continuous in the “orthoradial” direction of the cord which is perpendicular to its radius) so that it forms a continuous sleeve of a cross section that is advantageously near-circular.

It will also be noted that the rubber composition of this sheath may be crosslinkable or crosslinked, i.e. that it by definition comprises a crosslinking system suited to allowing the composition to crosslink as it is cured (i.e. to harden rather than to melt); thus, this rubber composition can be qualified as non-meltable because it cannot be melted by heating, whatever the temperature to which it is heated.

A “diene” elastomer or rubber means, in the known way, an elastomer derived at least in part (i.e. a homopolymer or a copolymer) from diene monomers (monomers bearing two carbon-carbon double bonds which may or may not be conjugated).

For preference, the crosslinking system of the rubber sheath is what is referred to as a vulcanization system, i.e. one based on sulphur (or on a sulphur donor) and a vulcanization primary accelerator. Various known secondary accelerators or vulcanization activators may be added to this basic vulcanization system.

The rubber composition of the sheath according to the invention may contain, in addition to the said crosslinking system, all the usual ingredients that can be used in rubber compositions for tires, such as reinforcing fillers based on carbon black and/or on a reinforcing inorganic filler such as silica, anti-ageing agents, for example antioxidants, extension oils, plasticizers or agents that make the compositions easier to process in the raw state, methylene acceptors and donors, resins, bismaleimides, known adhesion promoters of the RFS (resorcinol-formaldehyde-silica) type or metal salts, notably cobalt salts.

By way of preference, the composition of this sheath is chosen to be identical to the composition used for the rubber matrix that the cords according to the invention are intended to reinforce. Thus, there is no problem of potential incompatibility between the respective materials of the sheath and of the rubber matrix.

According to one alternative form of the invention, the metal reinforcing elements of at least one layer of the carcass reinforcement are layered metal cords of [L+M] or [L+M+N] construction that can be used as reinforcing elements for a carcass reinforcement of a tire, comprising a first layer C1 of L threads of diameter d₁ with L ranging from 1 to 4, surrounded by at least one intermediate layer C2 with M threads of diameter d₂ wound together in a helix at a pitch p₂ with M ranging from 3 to 12, the said layer C2 possibly being surrounded by an external layer C3 of N threads of diameter d₃ wound together in a helix at a pitch p₃ with N ranging from 8 to 20, a sheath made of a non-crosslinkable, crosslinkable or crosslinked rubber composition based on at least one diene elastomer in the [L+M] construction covering the said first layer C1 and in the [L+M+N] construction covering at least the said layer C2.

For preference, the diameter of the threads of the first layer of the internal layer (C1) is between 0.10 and 0.5 mm and the diameter of the threads of the external layers (C2, C3) is between 0.10 and 0.5 mm.

For preference also, the pitch of the helix at which the said threads of the external layer (C3) are wound is between 8 and 25 mm.

Within the meaning of the invention, the helix pitch represents the length, measured parallel to the axis of the cord, after which a thread of this pitch has made a complete turn about the axis of the cord; thus, if the axis is sectioned by two planes perpendicular to the said axis and separated by a length equal to the pitch of a thread of a layer of which the cord is made, the axis of this thread has, in these two planes, the same position on the two circles corresponding to the layer of the thread in question.

Advantageously, the cord has one, and more preferably still all, of the following features:
the layer C3 is a saturated layer, i.e. there is not enough space in this layer to add to it at least one (N+1)^{th} thread of diameter d₃, N then representing the maximum number of threads that can be wound in one layer around the layer C2;
the rubber sheath also covers the internal layer C1 and/or separates adjacent pairs of threads of the intermediate layer C2;
the rubber sheath covers practically all of the radially internal half-circumference of each thread of the layer C3 such that it separates adjacent pairs of threads of this layer C3.

For preference, the rubber sheath has a mean thickness ranging from 0.010 mm to 0.040 mm.

In general, the invention can be implemented to form the carcass reinforcement cords described hereinabove, using any type of metal thread, notably made of steel, for example threads made of carbon steel and/or threads made of stainless steel. Use is preferably made of a carbon steel but it is of course possible to use other steels or other alloys.

When a carbon steel is used, its carbon content (wt % of steel) is preferably between 0.1% and 1.2%, more preferably from 0.4% to 1.0%; these contents represent a good compromise between the mechanical properties required for the tire and the workability of the thread. It should be noted that a carbon content of between 0.5% and 0.6% ultimately makes such steels less expensive because they become easier to draw. Another advantageous embodiment of the invention may also, depending on the target application, involve using steels with a low carbon content, for example of between 0.2% and 0.5%, notably on account of the lower cost and greater ease of drawing.

The cord according to the invention can be obtained using various techniques known to those skilled in the art, for example in two steps, first of all by using an extrusion head to sheath the core or L+M intermediate structure (layers C1+C2) which step is followed in a second step by a final operation of cabling or twisting the remaining N threads (layer C3) around the layer C2 thus sheathed. The problem of tack in the raw state presented by the rubber sheath, during potential intermediate operations of spooling and unspooling, may be resolved in a way known to those skilled in the art, for example by use of a plastic interlayer film.

Such cords of at least one carcass reinforcing layer are, for example, selected from the cords described in patent applications WO 2005/071157, WO 2010/012411, WO 2010/054790 and WO 2010/054791.

According to an advantageous alternative form of embodiment of the invention, the layer of circumferential reinforcing elements has an axial width greater than 0.5×S.

S is the maximum axial width of the tire when the latter is mounted on its service rim and inflated to its recommended pressure.

The axial widths of the layers of reinforcing elements are measured on a cross section of a tire, the tire therefore being in an uninflated state.

According to a preferred embodiment of the invention, at least two working crown layers have different axial widths, the difference between the axial width of the axially widest working crown layer and the axial width of the axially least wide working crown layer being between 10 and 30 mm.

According to one preferred embodiment of the invention, the layer of circumferential reinforcing elements is positioned radially between two working crown layers.

According to this embodiment of the invention, the layer of circumferential reinforcing elements makes it possible to limit to a greater extent the degree to which the reinforcing elements of the carcass reinforcement are compressed compared with a similar layer placed radially on the outside of the working layers. It is preferably radially separated from the carcass reinforcement by at least one working layer so as to limit the demands placed on the said reinforcing elements and not cause them excessive fatigue.

Advantageously also according to the invention, the axial widths of the working crown layers radially adjacent to the layer of circumferential reinforcing elements are greater than the axial width of the said layer of circumferential reinforcing elements and, for preference, the said working crown layers adjacent to the layer of circumferential reinforcing elements are, on each side of the equatorial plane and in the immediate axial continuation of the layer of circumferential reinforcing elements, coupled over an axial width and then later uncoupled by the said first layer of rubber compound at least over the remainder of the width common to the said two working layers.

The presence of such couplings between the working crown layers adjacent to the layer of circumferential reinforcing elements allows a reduction in tensile stresses acting on the axially outermost circumferential elements located closest to the coupling.

According to one advantageous embodiment of the invention, the reinforcing elements of the said at least one layer of circumferential reinforcing elements are metal reinforcing elements having a secant modulus at 0.7% elongation of between 10 and 120 GPa and a maximum tangent modulus of less than 150 GPa.

According to a preferred embodiment, the secant modulus of the reinforcing elements at 0.7% elongation is less than 100 GPa and greater than 20 GPa, preferably between 30 and 90 GPa, and more preferably still, less than 80 GPa.

For preference also, the maximum tangent modulus of the reinforcing elements is less than 130 GPa and more preferably still, less than 120 GPa.

The modulus values given hereinabove are measured on a curve of tensile stress against elongation, the tensile stress corresponding to the measured tension, with a preload of 5 N, divided by the cross section of metal of the reinforcing element.

According to one preferred embodiment, the reinforcing elements of at least one layer of circumferential reinforcing elements are metal reinforcing elements having a curve of tensile stress as a function of relative elongation that has shallow gradients for small elongations and a substantially constant and steep gradient for greater elongations. Such reinforcing elements of the layer of circumferential reinforcing elements are usually referred to as “bi-modulus” elements.

According to a preferred embodiment of the invention, the substantially constant and steep gradient appears from a relative elongation of between 0.4% and 0.7%.

The various characteristics of the reinforcing elements which have been listed hereinabove are measured on reinforcing elements that have been taken from tires.

Reinforcing elements more particularly suited to the production of at least one layer of circumferential reinforcing elements according to the invention are, for example, assemblies of 3×(0.26+6×0.23) 5.0/7.5 SS construction. Such a cord has a secant modulus 0.7% equal to 45 GPa and a maximum tangent modulus equal to 100 GPa, these being measured on a curve of tensile stress as a function of elongation, the tensile stress corresponding to the measured tension, with a preload of 5 N, divided by the cross section of metal in the reinforcing element, namely 0.98 mm² in the case of the example being considered.

According to a second embodiment of the invention, the circumferential reinforcing elements may be formed of metallic elements and cut to form sections having a length very much shorter than the circumference of the least-long layer, but preferably greater than 0.1 times the said circumference, the cuts between sections being axially offset from one another. For preference also, the elastic modulus in tension per unit width of the layer of circumferential reinforcing elements is less than the elastic modulus in tension, measured under the same conditions, of the most extensible working crown layer. Such an embodiment makes it possible, in a simple way, to give the layer of circumferential reinforcing elements a modulus that can easily be adjusted (by choosing the gaps between portions of the same row) but which in all cases is lower than the modulus of the layer made up of the same metal elements but continuous ones, the modulus of the layer of circumferential reinforcing elements being measured on a vulcanized layer of cut elements taken from the tire.

According to a third embodiment of the invention, the circumferential reinforcing elements are wavy metal elements, the ratio a/λ of the amplitude of the wave to the wavelength being at most equal to 0.09. For preference, the elastic modulus in tension per unit width of the layer of circumferential reinforcing elements is less than the elastic modulus in tension, measured under the same conditions, of the most extensible working crown layer.

Again in order to reduce the mass of the tires, according to an advantageous alternative form of the invention, the reinforcing elements of the said at least two working crown layers have a diameter less than 1.1 mm, the said reinforcing elements being themselves made up of threads of diameter less than 0.3 mm.

Advantageously according to this alternative form of embodiment of the invention, the reinforcing elements of the said at least two working crown layers are inextensible reinforcing elements.

For preference also, they are metal cords.

According to an advantageous alternative form of the invention, the reinforcing elements of the said at least two working layers are metal cords with saturated layers exhibiting, in the test referred to as the permeability test, a flow rate of less than 5 cm³/min.

According to one advantageous embodiment of the invention, the said metal reinforcing elements which, in the test referred to as the permeability test, exhibit a flow rate of less than 5 cm³/min and which belong to the said at least two working layers are cords having at least two saturated layers, at least one internal layer being sheathed with a layer made of a polymer composition such as a crosslinkable or crosslinked rubber composition, preferably based on at least one diene elastomer.

The results obtained according to this alternative form of embodiment of the invention have effectively demonstrated that for performance that is at least equivalent in terms of endurance and wear, the tires have an even lower mass. This is because reducing the diameter of the reinforcing elements in the working layers compared with that of the said reinforcing elements in conventional tires leads to a further weight saving. The usual diameter of the said reinforcing elements is usually greater than 1.3 mm.

For preference, according to this alternative form of embodiment of the invention, the said reinforcing elements of the said at least two working crown layers satisfy the following relationship:

(Fr×4 cos²α)/(P×0.75 Pg×Ø)<5,

where Fr is the rupture force of the reinforcing elements measured on reinforcing elements taken from the tire, expressed in daN,

α is the mean angle formed between the reinforcing elements of the said at least two working crown layers and the circumferential direction at the equatorial plane,

P is the mean pitch at which the reinforcing elements of the said at least two working crown layers are spaced, at the equatorial plane and expressed in mm,

Pg is the tire inflation pressure, corresponding to the nominal load, expressed in daN/mm²,

Ø is the internal diameter of the tire measured in the equatorial plane and expressed in mm.

Within the meaning of the invention, the pitch in part of the layer of reinforcing elements is the distance between two consecutive reinforcing elements. It is measured between the longitudinal axes of the said reinforcing elements in a direction perpendicular to at least one of the said longitudinal axes. The pitches Pi of the said at least two working crown layers are measured on an unmounted tire.

The internal diameter Ø is measured on a tire mounted and inflated to the inflation pressure Pg.

The diameter d of the reinforcing elements of the said at least two working layers is measured on reinforcing elements taken from the tire and previously rid of any external polymer residue.

The relationship (Fr×4 cos²α)/(P×0.75 Pg×Ø)<5 expresses a condition according to which the inventors consider the improvement to circumferential rigidity by the working layers notably in the crown of the tire to be sufficient taking into consideration the presence of at least one layer of reinforcing elements oriented circumferentially.

The inventors have also been able to demonstrate that this lightening of the crown reinforcement of the tire is accompanied by a reduction in its thickness because of the reduction in the diameter of the reinforcing elements of the working layers. This reduction in the thickness of the working reinforcement is associated with polymer compound thicknesses that are reduced in comparison with those of conventional tires.

The inventors have also demonstrated that the reduction in circumferential rigidity that results from the lightening of the working layers makes it possible to reduce the said overall circumferential rigidity of the crown reinforcement of the tire and notably reduce it in the middle of the tire, namely around the equatorial plane, thus making it possible to improve the tire properties in terms of wear. This is because the uneven wear that occurs between the middle and the edge of the tread under certain running conditions is reduced in comparison with what may be observed in more conventional designs. The reduction in the diameters of the reinforcing elements of the said at least two working layers allows a further reduction in the sensitivity of the tire to tread attack, the crown design according to the invention being more flexible overall than with more conventional tires.

A preferred embodiment of the invention also plans for the crown reinforcement to be supplemented radially on the outside by at least one additional layer, referred to as a protective layer, of reinforcing elements referred to as elastic elements, oriented with respect to the circumferential direction at an angle of between 10° and 45° and in the same direction as the angle formed by the elements of the working layer radially adjacent to it.

According to any one of the embodiments of the invention mentioned previously, the crown reinforcement may be further supplemented, radially on the inside between the carcass reinforcement and the radially inner working layer closest to the said carcass reinforcement, by a layer of triangulation metal reinforcing elements made of steel making, with the circumferential direction, an angle greater than 50° and in the same direction as the angle formed by the reinforcing elements of the radially closest layer of the carcass reinforcement.

The invention also proposes a mounted assembly made up of a wheel the rim of which has a nominal diameter greater than or equal to 22.5 inches and of a tire according to that described hereinabove in its generic form or in its alternative forms or even in its preferred or advantageous embodiment forms.

Further details and advantageous features of the invention will become apparent hereinafter from the description of some exemplary embodiments of the invention given with reference to the figures which depict:

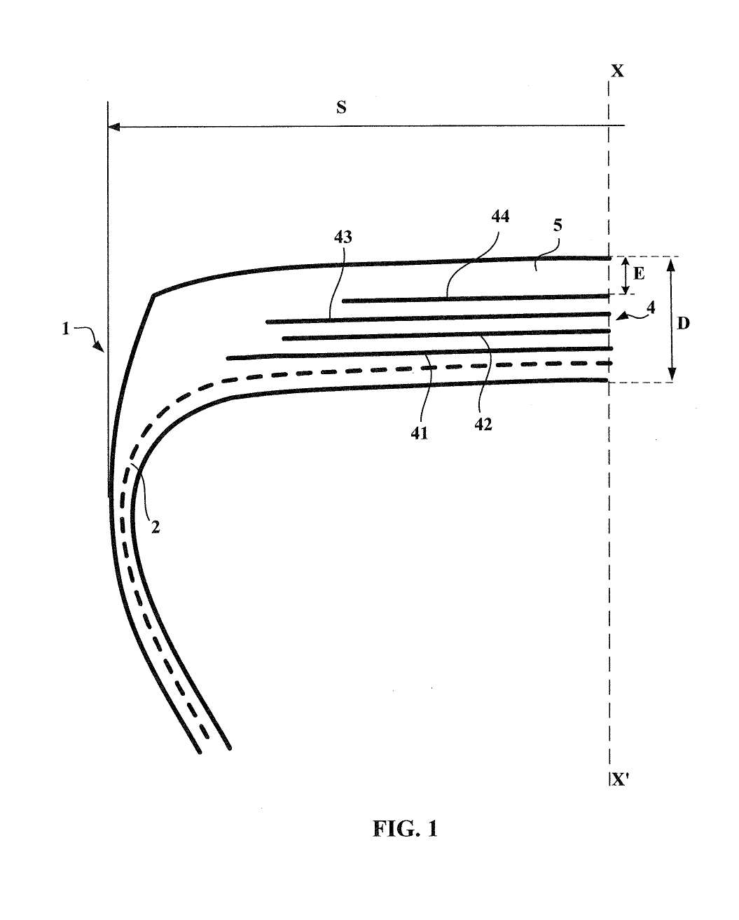

FIG. 1, a meridian diagrammatical view of a tire according to one embodiment of the invention,

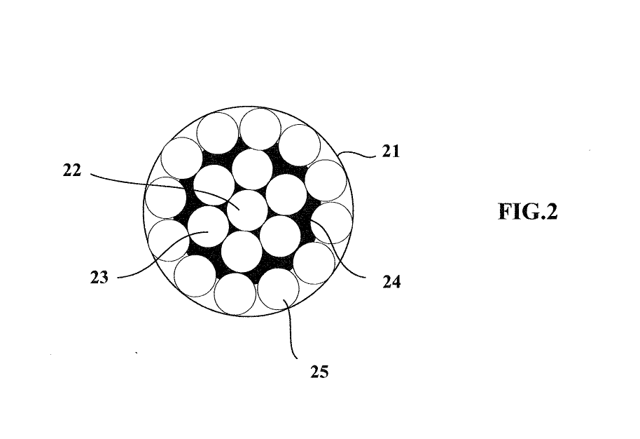

FIG. 2, a schematic depiction of a cross section of one example of a carcass reinforcement cord of the tire of FIG. 1.

In order to make them easier to understand, the figures are not drawn to scale.

FIG. 1 depicts only a half view of a tire which extends symmetrically about the axis XX′ which represents the circumferential mid plane or equatorial plane of a tire.

In FIG. 1, the tire 1, of size 315/70 R 22.5, has an aspect ratio H/S of 0.70, H being the height of the tire 1 on its mounting rim and S its maximum axial width. The said tire 1 comprises a radial carcass reinforcement 2 anchored in two beads, not depicted in the figure. The carcass reinforcement is formed of a single layer of metal cords. This carcass reinforcement 2 is hooped by a crown reinforcement 4, formed radially from the inside outwards:
of a first working layer 41 formed of inextensible non-wrapped metal cords of 2+7×0.35 7.5/15 SS construction, forming at the equatorial plane an angle of 25° with the circumferential direction.
of a layer of circumferential reinforcing elements 42 which is formed of metal cords made of stainless steel of the “bimodulus” type of 3×(0.26+6×0.23) 5/7.5 SS construction,
of a second working layer 43 formed of non-wrapped inextensible metal cords of 2+7×0.35 7.5/15 SS construction, making an angle of 25° with the circumferential direction at the equatorial plane and crossed with the metal cords of the layer 41,
of a protective layer 44 formed of elastic metal cords of 3×2×0.35 4/6 SS construction.

The axial width L41 of the first working layer 41 is equal to 234 mm.

The axial width L42 of the layer of circumferential reinforcing elements 42 is equal to 196 mm.

The axial width L43 of the second working layer 43 is equal to 216 mm.

The crown reinforcement is itself capped by a tread 5.

The thickness of the crown as measured in the radial direction in the equatorial plane between the exterior surface of the tread and the interior surface of the tire is equal to 30 mm.

The thickness of the tread as measured in the radial direction in the equatorial plane between a radially outermost point of a reinforcing element of the protective layer 44 and the exterior surface of the tread is equal to 19 mm.

The thicknesses are measured on a cross section of the tire, the latter therefore not being mounted or inflated.

As far as the carcass reinforcement is concerned, according to the invention the reinforcing elements are metal cords of 1×0.20+6×0.18+12×0.18 10/10 ZZ construction.

Such cords have a diameter of 0.95 mm.

FIG. 2 illustrates a schematic depiction of the cross section of such a carcass reinforcement cord 21 of the tire 1 of FIG. 1. This cord 21 is a non-wrapped layered cord of 1+6+12 structure made up of a central core formed of a thread 22, of an intermediate layer formed of six threads 23 and of an external layer formed of twelve threads 25.

It has the following characteristics (d and p in mm):
structure 1+6+12;
d₁=0.20 (mm);
d₂=0.18 (mm);
p₂=10 (mm);
d₃=0.18 (mm);
p₂=10 (mm);
(d₂/d₃)=1;
   where d₂, p₂ are respectively the diameter and helix pitch of the intermediate layer and d₃ and p₃ are respectively the diameter and helix pitch of the threads of the external layer.

The heart of the cord made up of the central core formed of the thread 22 and of the intermediate layer formed of the six threads 23 is, according to the invention, sheathed with a rubber composition 24 based on unvulcanized diene elastomer (in the raw state). The sheathing is performed by an extrusion head extruding the heart made up of the thread 22 surrounded by the six threads 23 and is followed by a final operation of twisting or cabling the twelve threads 25 around the heart thus sheathed.

The penetratability of the cord 21, measured according to the method described hereinabove, is equal to 95%.

The elastomeric composition that makes up the rubber sheath 24 is made from a composition as described hereinabove and in this particular instance has the same formulation, based on natural rubber and carbon black, as the skim layers 13 of the carcass reinforcement that the cords are intended to reinforce.

According to the invention, the cords of the carcass reinforcement which have a diameter less than 1 mm and are made up of threads with a diameter greater than 0.16 mm, make it possible to produce tires of which the performance in terms of endurance is satisfactory, at the inflation pressures according to the invention.

Endurance testing has been carried out on the tire produced according to the invention, and compared against a reference tire identical in size.

The reference tire has the same crown reinforcement and comprises a carcass reinforcement the cords of which are of 1×0.20+6×0.18+12×0.18 10/10 ZZ formula, the said cords having no sheathing layer made of a rubber composition 24 based on diene elastomer.

The radial distance D measured in the equatorial plane between the exterior surface of the tread and the interior surface of the tire is equal to 35 mm.

The thickness of the tread in the equatorial plane is equal to 23 mm.

The tire according to the invention thus allows a weight saving of 6 kg, representing approximately 9% of the overall mass of the tire as compared with a reference tire.

The tire according to the invention is inflated to a pressure of 7.2 bar. The reference tire is inflated to a pressure of 9 bar.

The relative deflection under nominal load of the tire according to the invention is equal to 18.5%.

The relative deflection under nominal load of the reference tire is equal to 15%.

The tests carried out consisted in destructive rolling-road running tests; this type of test on a rolling road simulates long-duration tests on a circuit in a straight line.

The loading conditions are the same for the tire according to the invention and the reference tire.

The tire according to the invention covered a distance substantially equivalent to that covered by the reference tire.

Other tire wear performance tests were carried out using the same tires. The wear tests are carried out in the same way for the two tires by running vehicles fitted with these tires on tracks representative of conventional use. After covering a distance of 50 000 km, the degree of tire wear is substantially identical in terms of appearance and level of wear.

The inventors also demonstrated during testing that the tire according to the invention leads to rolling resistance performance that is an improvement over the reference tire despite the fact that it is being used at an inflation pressure of the order of 20% lower. Indeed a person skilled in the art might have expected under these conditions that the rolling resistance of the tire would worsen. It would appear that the weight savings are enough to compensate for the effect caused by the pressure and even improve this performance.

Other tires according to the invention were also produced; compared to those produced previously, only the crown reinforcement was modified by the use of cords of the sheath to 0.26+6×0.26 15 S type. The tire thus produced according to the invention thus gives a weight saving of 7 kg representing approximately 10.5% of the overall weight of the tire as compared with the reference tire.

Moreover, the same tests were conducted using this tire inflated to a pressure of 7.2 bar and demonstrated wear and endurance performance similar to that obtained with the tires described previously.

Finally, the rolling resistance performance is improved still further with this second tire produced according to the invention.

1. A tire for a vehicle of the heavy vehicle type equipped with wheels the rims of which have a nominal diameter greater than or equal to 22.5 inches, with a radial carcass reinforcement of which the nominal pressure (Pn) is between 4 and 8 bar and the relative deflection (Fr) under nominal load satisfies the relationship Fr≧0.14+(Pₙ−5)×0.013, comprising a crown reinforcement formed of at least two working crown layers of reinforcing elements, crossed from one layer to the other and making with the circumferential direction angles of between 10° and 45°, itself capped radially by a tread, the said tread being connected to two beads by two sidewalls, wherein crown reinforcement additionally comprises at least one layer of reinforcing elements that are parallel to one another within the layer and oriented circumferentially, wherein the reinforcing elements of the carcass reinforcement have a diameter less than 1 mm, wherein said reinforcing elements of the carcass reinforcement are made up of threads of diameters strictly greater than 0.16 mm, wherein said reinforcing elements of the carcass reinforcement are metal cords, advantageously non-wrapped cords, exhibiting, in what is known as the permeability test, a flow rate less than 20 cm³/min and wherein the radial distance (D) measured in the equatorial plane between the exterior surface of the tread and the interior surface of the tire is less than 32 mm.

2. The tire according to claim 1, wherein said reinforcing elements of the carcass reinforcement are made up of threads of diameter less than or equal to 0.20 mm.

3. The tire according to claim 1, wherein the nominal pressure of the tire is less than 7.5 bar.

4. The tire according to claim 1, wherein the relative deflection of the tire under nominal load is greater than 18%.

5. The tire according to claim 1, wherein the aspect ratio −H/S is strictly greater than 0.64.

6. The tire according to claim 1, wherein the radial distance (D), measured in the equatorial plane, between the exterior surface of the tread and the interior surface of the tire is greater than 15 mm.

7. The tire according to claim 1, wherein the ratio between the width of the tread and the maximum width of the tire is less than or equal to 0.80.

8. The tire according to claim 1, wherein the metal reinforcing elements of at least one layer of the carcass reinforcement are cords having at least two layers and wherein at least an internal layer is sheathed by a layer made of a polymer composition such as a composition of a rubber that is non-crosslinkable, crosslinkable or crosslinked, preferably based on at least one diene elastomer.

9. A tire for a vehicle of the heavy vehicle type equipped with wheels the rims of which have a nominal diameter greater than or equal to 22.5 inches, with a radial carcass reinforcement of which the nominal pressure (Pn) is between 4 and 8 bar and the relative deflection (Fr) under nominal load satisfies the relationship Fr≧0.14+(Pn−5)×0.013, comprising a crown reinforcement formed of at least two working crown layers of reinforcing elements, crossed from one layer to the other and making with the circumferential direction angles of between 10° and 45°, itself capped radially by a tread, said tread being connected to two beads by two sidewalls, wherein the crown reinforcement additionally comprises at least one layer of reinforcing elements that are parallel to one another within the layer and oriented circumferentially, wherein the reinforcing elements of the carcass reinforcement have a diameter less than 1 mm, wherein said reinforcing elements of the carcass reinforcement are made up of threads of diameters strictly greater than 0.16 mm, wherein said metal reinforcing elements of at least one layer of the carcass reinforcement are cords having at least two layers, wherein at least an internal layer of said cords is sheathed by a layer made of a polymer composition such as a composition of a rubber that is non-crosslinkable, crosslinkable or crosslinked, and wherein the radial distance (D) measured in the equatorial plane between the exterior surface of the tread and the interior surface of the tire is less than 32 mm.

10. The tire according to claim 9, wherein the crown reinforcement comprises, between two working crown layers, at least one layer of reinforcing elements that are parallel to one another within the layer and oriented circumferentially.

11. The tire according to claim 9, wherein the reinforcing elements of the said at least one layer of reinforcing elements that are parallel to one another within the layer and oriented circumferentially are metal reinforcing elements having a secant modulus at 0.7% elongation of between 10 and 120 GPa and a maximum tangent modulus of less than 150 GPa.

12. The tire according to claim 9, wherein the reinforcing elements of said at least two working crown layers have a diameter less than 1.1 mm, said reinforcing elements being themselves made up of threads of diameter less than 0.3 mm.

13. The tire according to claim 9, wherein the crown reinforcement further comprises a triangulation layer formed of metal reinforcing elements making with the circumferential direction angles greater than 50° in terms of absolute value.

14. The tire according to claim 9, wherein the crown reinforcement is supplemented radially on the outside by at least one additional layer, referred to as protective layer, of reinforcing elements referred to as elastic elements, oriented with respect to the circumferential direction at an angle of between 10° and 45° and in the same direction as the angle formed by the inextensible elements of the working layer radially adjacent to it.

15. The tire according to claim 1, wherein the crown reinforcement comprises, between two working crown layers, at least one layer of reinforcing elements that are parallel to one another within the layer and oriented circumferentially.

16. The tire according to claim 1, wherein the reinforcing elements of said at least one layer of reinforcing elements that are parallel to one another within the layer and oriented circumferentially are metal reinforcing elements having a secant modulus at 0.7% elongation of between 10 and 120 GPa and a maximum tangent modulus of less than 150 GPa.

17. The tire according to claim 1, wherein the reinforcing elements of said at least two working crown layers have a diameter less than 1.1 mm, said reinforcing elements being themselves made up of threads of diameter less than 0.3 mm.

18. The tire according to claim 1, wherein the crown reinforcement further comprises a triangulation layer formed of metal reinforcing elements making with the circumferential direction angles greater than 50° in terms of absolute value.

19. The tire according to claim 1, wherein the crown reinforcement is supplemented radially on the outside by at least one additional layer, referred to as protective layer, of reinforcing elements referred to as elastic elements, oriented with respect to the circumferential direction at an angle of between 10° and 45° and in the same direction as the angle formed by the inextensible elements of the working layer radially adjacent to it.

20. The tire according to claim 9, wherein the composition of a rubber that is non-crosslinkable, crosslinkable or crosslinked is based on at least one diene elastomer.
